(19) United States
(12) Patent Application Publication
(10) Pub. No.: US 2020/0402011 A1
(43) Pub. Date: Dec. 24, 2020

(54) CAREER PLANNING WITH THE WHOLE FAMILY IN MIND

(71) Applicant: JPMorgan Chase Bank, N.A., New York, NY (US)

(72) Inventor: John Andrew RAPPA, Lithia, FL (US)

(73) Assignee: JPMorgan Chase Bank, N.A., New York, NY (US)

(21) Appl. No.: 16/445,706

(22) Filed: Jun. 19, 2019

(51) Int. Cl. G06Q 10/10; G06F 7/02

(52) U.S. Cl. CPC G06Q 10/1053; G06F 7/02

(57) ABSTRACT

Various systems, methods, and media for providing an individual with at least one option for relocation are provided. Individual occupation information is obtained that corresponds to a primary occupation, an employment history, or an education of the individual. Individual preference information is obtained that corresponds to a lifestyle preference of the individual. Current location information is obtained, from a predetermined source, that corresponds to a plurality of locations. The individual occupation information and the individual preference information are correlated with the current location information. At least one location is provided, as the at least one option for relocation, to the individual.

### BACKGROUND

### 1. Field of the Disclosure

The present disclosure generally relates to providing options for relocation to individuals and, more particularly, to systems, methods, and media for providing an individual with options for relocation based on obtained information.

### 2. Background Information

For many families, and individuals, there will come a time when relocation may be the solution to further one's career or maintain one's current job. Unfortunately, at such time, it is often difficult to balance the needs of the career or current job and familial desires. As a result, families often appear to make seemingly uninformed, or ill-informed, decisions.

### SUMMARY OF THE DISCLOSURE

The present disclosure, through one or more of its various aspects, embodiments, and/or specific features or sub-components, provides, inter alia, various systems, servers, devices, methods, media, programs, and platforms for providing a family, or an individual, with at least one informed option for relocation based on obtained information.

The various aspects, embodiments, features, and/or sub-components provide a single source for families, or individuals, looking to relocate as a result of a new career opportunity. The various aspects, embodiments, features, and/or sub-components distinguish between types of jobs available as well as provide a list of locations that fit lifestyle criteria or preferences. Accordingly, by the present disclosure, an informed, intelligent, and customizable relocation process is provided that balances career planning with familial desires.

According to an aspect of the present disclosure, a system for providing an individual with at least one option for relocation based on obtained information is provided. The system includes a processor and a memory. The memory includes instructions that, when executed by the processor, cause the processor to perform operations including: obtaining individual occupation information, with the individual occupation information corresponding to at least one of a primary occupation of the individual, an employment history of the individual, or an education of the individual; obtaining individual preference information, with the individual preference information corresponding to at least one lifestyle preference of the individual; obtaining current location information from at least one predetermined source, with the current location information corresponding to a plurality of locations; correlating the individual occupation information and the individual preference information with the current location information; determining, from among the plurality of locations and based on the correlating, at least one location as the at least one option for relocation; and providing the at least one location as the at least one option for relocation to the individual.

According to another aspect of the present disclosure, the operations further obtain second occupation information. The second occupation information corresponds to at least one of an occupation of a second individual, an employment history of the second individual, or an education of the second individual. In this regard, the correlating correlates the individual occupation information, the individual preference information, and the second occupation information with the current location information to determine the at least one location as the at least one option for relocation.

According to yet another aspect of the present disclosure, the individual is associated with an entity and the second individual is unassociated with the entity. The at least one predetermined source, from which the current location information is obtained, includes a first database of the entity. The first database includes first position information associated with the entity throughout the plurality of locations. The current location information includes the first position information. Further, in the correlating, the individual occupation information is correlated with the first position information of the entity and the second occupation information is not correlated with the first position information of the entity. The at least one predetermined source, from which the current location information is obtained, further includes a second database unassociated with the entity. The second database includes second position information unassociated with the entity throughout the plurality of locations. The current location information further includes the second position information. Lastly, in the correlating, the second occupation information is correlated with the second position information and the individual occupation information is not correlated with the second position information.

According to a further aspect of the present disclosure, the operations compute, based on the correlating and for the at least one location, a plurality of scores. The plurality of scores include: a profile score corresponding to a match between the at least one location and the individual occupation information; a lifestyle score corresponding to a match between the at least one location and the individual preference information; and an occupation score corresponding to a match between the at least one location and the second occupation information. In this regard, the operations provide, to the individual: the profile score; a first composite score of the profile score and the lifestyle score; and a second composite score of the profile score, the lifestyle score, and the occupation score.

According to still a further another aspect of the present disclosure, the operations obtain second occupation information, with the second occupation information corresponding to a secondary occupation of the individual and the secondary occupation being different than the primary occupation. The correlating correlates the individual preference information, the individual occupation information, and the second occupation information with the current location information to determine the at least one location as the at least one option for relocation.

According to another aspect of the present disclosure, the operations receive a selection of an occupation for the individual. In this regard, the correlating includes searching the current location information using the selected occupation.

According to yet another aspect of the present disclosure, the individual is associated with an entity, and the at least one predetermined source, from which the current location information is obtained, includes a database of the entity. The database includes position information associated with the entity throughout the plurality of locations, with the current location information including the position information.

According to a further aspect of the present disclosure, the operations obtain first skill information of the individual, with the first skill information including an evaluation of at least one skill of the individual in association with the entity. The operations further obtain second skill information of a plurality of individuals, with the second skill information including an evaluation of the at least one skill for each of the plurality of individuals and the plurality of individuals also being associated with the entity. The operations even further correlate the first skill information of the individual with the second skill information of the plurality of individuals. The position information, included in the current location information, is obtained based on the correlating of the first skill information with the second skill information.

According to still a further another aspect of the present disclosure, the correlating of the first skill information with the second skill information includes determinations of whether the individual is likely to succeed at positions within the position information. The position information, which is included in the current location information, is filtered based on the determinations.

According to another aspect of the present disclosure, the correlating of the first skill information with the second skill information includes determinations of whether the individual is likely to succeed at positions within the position information. The position information, which is included in the current location information, is weighted based on the determinations.

According to yet another aspect of the present disclosure, the operations obtain first profile information of the individual, obtain second profile information of a plurality of individuals, and correlate the first profile information of the individual with the second profile information of the plurality of individuals. The plurality of individuals also is associated with the entity. The position information, included in the current location information, is obtained based on the correlating of the first profile information with the second profile information.

According to a further aspect of the present disclosure, the operations: compare the individual occupation information with the position information to determine shortcomings of the individual occupation information for a position within the position information; determine, based on the individual occupation information, a roadmap for overcoming the shortcomings for the position; and provide the roadmap to the individual.

According to still a further another aspect of the present disclosure, the roadmap for overcoming the shortcomings for the position is determined by accessing an employee profile of the individual, with the employee profile being stored in the database of the entity.

According to another aspect of the present disclosure, the processor automatically accesses at least one of a social media platform, a financial record, a phone record, or a credit history to obtain the individual preference information. The processor automatically accesses an employee profile of the individual to obtain the individual occupation information, with the employee profile being stored in the database of the entity.

According to yet another aspect of the present disclosure, the obtaining of the individual preference information includes, the processor accessing a social media platform of the individual, and locations of persons associated with the individual on the social media platform being identified as a lifestyle preference.

According to a further aspect of the present disclosure, the obtaining of the individual occupation information includes: accessing, by the processor, a social media platform of the individual; and identifying locations of persons associated with the individual on the social media platform to determine locations of preference, with the persons corresponding to the individual as networking opportunities.

According to still a further another aspect of the present disclosure, the obtaining of the individual preference information includes: accessing, by the processor, a phone record of a phone of the individual; and identifying, as a lifestyle preference, at least one of destinations of outgoing communications, originations of incoming communications, or locations corresponding to a positioning trace of the phone.

According to another aspect of the present disclosure, the obtaining of the individual preference information includes: accessing, by the processor, at least one of a financial record or a credit history of the individual; and identifying at least one lifestyle preference of the individual based on the one of the financial record or the credit history.

According to yet another aspect of the present disclosure, a method for providing an individual with at least one option for relocation based on obtained information is provided. The method comprises: obtaining individual occupation information, with the individual occupation information corresponding to at least one of a primary occupation of the individual, an employment history of the individual, or an education of the individual; obtaining individual preference information, with the individual preference information corresponding to at least one lifestyle preference of the individual; obtaining current location information from at least one predetermined source, with the current location information corresponding to a plurality of locations; correlating the individual occupation information and the individual preference information with the current location information; and determining, with a processor and from among the plurality of locations and based on the correlating, at least one location as the at least one option for relocation; and providing the at least one location as the at least one option for relocation to the individual.

According to a further aspect of the present disclosure, a non-transitory computer-readable medium including a set of instructions for providing an individual with at least one option for relocation based on obtained information is provided. The set of instructions, when executed by a computer, causes the computer to perform operations comprising: obtaining individual occupation information, with the individual occupation information corresponding to at least one of a primary occupation of the individual, an employment history of the individual, or an education of the individual; obtaining individual preference information, with the individual preference information corresponding to at least one lifestyle preference of the individual; obtaining current location information from at least one predetermined source, with the current location information corresponding to a plurality of locations; correlating the individual occupation information and the individual preference information with the current location information; determining, from among the plurality of locations and based on the correlating, at least one location as the at least one option for relocation; and providing the at least one location as the at least one option for relocation to the individual.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary system for providing an individual with at least one option for relocation based on obtained information, according to an embodiment of the present disclosure.

FIG. 2 illustrates an exemplary diagram of a network environment for providing an individual with at least one option for relocation, according to an embodiment of the present disclosure.

FIG. 3 illustrates an exemplary schematic of information flow in a system for providing an individual with at least one option for relocation, according to an embodiment of the present disclosure.

FIG. 4 illustrates an exemplary schematic for providing relocation options to an individual, according to an embodiment of the present disclosure.

FIG. 5 illustrates an exemplary listing of growth by occupational groups, as provided by the U.S. Bureau of Labor Statistics.

FIG. 6 illustrates an exemplary listing of profile matches, according to an embodiment of the present disclosure.

FIG. 7 illustrates an exemplary schematic of a skills comparison, according to an embodiment of the present disclosure.

FIG. 8 illustrates an exemplary embodiment of a profile database, according to an embodiment of the present disclosure.

FIG. 9 illustrates an exemplary embodiment of a display for proving a roadmap to an individual, according to an embodiment of the present disclosure.

FIG. 10 illustrates a further exemplary embodiment of a display for proving a roadmap to an individual, according to an additional embodiment of the present disclosure.

FIG. 11 illustrates an exemplary embodiment of a display for proving relocation options to an individual, according to an additional embodiment of the present disclosure.

FIG. 12 illustrates an exemplary method for providing an individual with at least one option for relocation, according to an embodiment of the present disclosure.

### DETAILED DESCRIPTION

Through one or more of its various aspects, embodiments and/or specific features or sub-components of the present disclosure, are intended to bring out one or more of the advantages as specifically described above and noted below.

That is, the aspects, embodiments, features, and/or components provide a single source for families, or individuals, looking to relocate as a result of a new career opportunity. The various aspects, embodiments, features, and/or components distinguish between types of jobs available as well as provide a list of locations that fit lifestyle criteria or preferences, thereby providing an intelligent and customizable relocation process that balances career planning with familial desires.

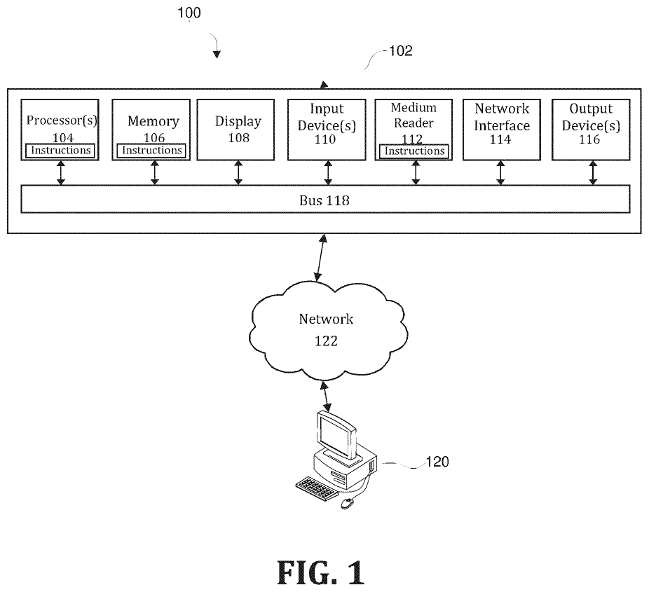

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-Ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a video display 108, such as a liquid crystal display (LCD), an organic light emitting diode (OLED), a flat panel display, a solid state display, a cathode ray tube (CRT). a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read anyone or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present disclosure, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present disclosure. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

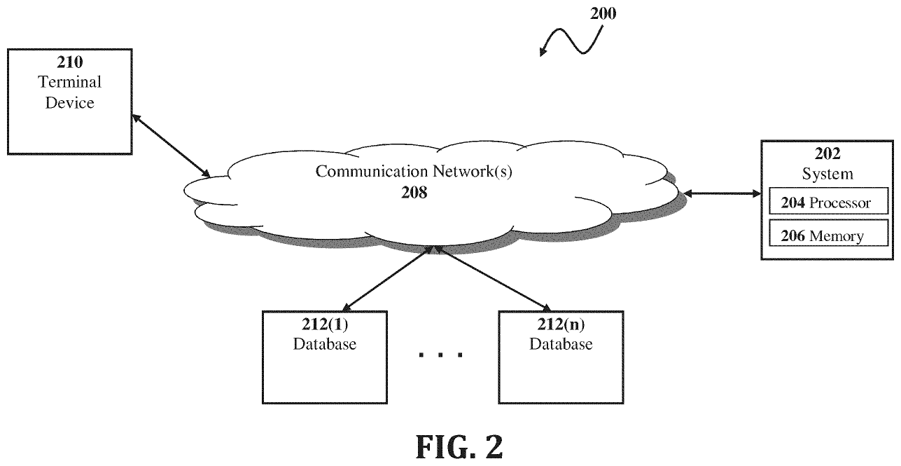

Referring to FIG. 2, a network environment 200 for providing an individual with at least one option for relocation is illustrated. The network environment 200 includes a system 202. The system 202 may be the same or similar to the computer system 102 as described with respect to FIG. 1.

As will be described herein, the individual may be any person or persons with any preexisting, other, or no relationship with the system 202. The individual may be included within or comprise a family, or the individual may be included within or comprise any other group of persons. The embodiments described herein generally describe the individual as being, for example, a head-of-household of a familial group. Nevertheless, it is to be known and understood that such dynamic is principally used for convenience and clarity. Any other dynamic may surround the individual and any of the other persons described herein.

Further, while the term relocate is used herein, it is also to be known and understood that this term is merely exemplary and is not limiting or exhaustive. That is, the individual may be seeking a location, place of domicile, or other residence for the first time, and thus, not be relocating. Also, the individual may not maintain a current location. Again, the term relocate is principally used for convenience and clarity, and it is to be known and understood that such term and related terms are merely exemplary and that an additional term or terms may be used without departing from the scope of the present disclosure.

The system 202 may include, among other features, a processor 204 and a memory 206. While the system 202 is solely shown as including such features in FIG. 2, it is to be known and understood that the system 202 may include any combination of features as described with respect to the computer system 102, as well as any additional or alternative features which are known and understood in the art. The processor 204 may be the same or similar to the processor 104 as described with respect to FIG. 1, and the memory 206 may be the same or similar to the memory 106 as described with respect to FIG. 1. The memory 206 may include a program or set of instructions that, when executed by the processor 204, cause the processor 204 to perform operations. Of course, in addition or alternatively to being implemented by software, any combination of the operations may be implemented by hardware.

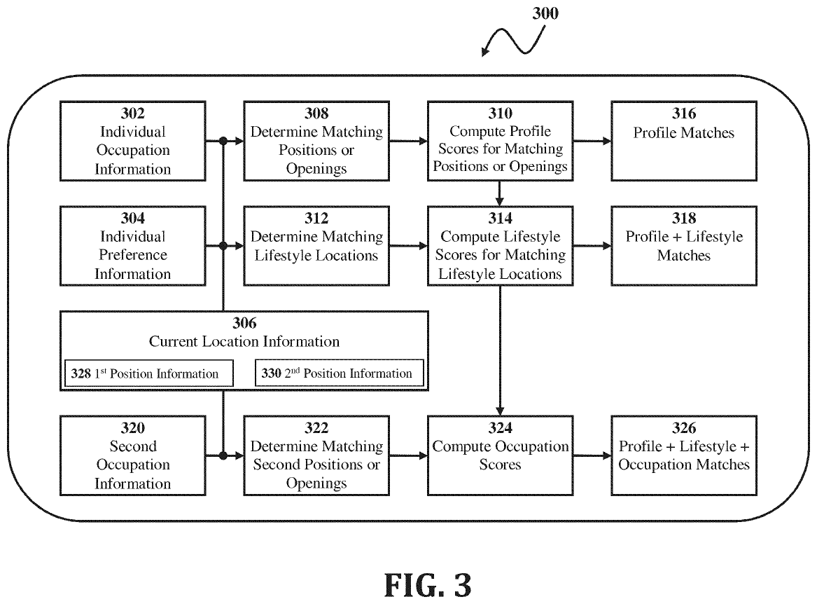

The operations include the processor 204 obtaining individual occupation information. In this regard, FIG. 3 of the present disclosure illustrates an exemplary schematic of an information flow of the system 202 at 300. The individual occupation information is shown in FIG. 3 at 302, and may be obtained directly or indirectly by the processor 204. For example, the system 202 may include a network interface (not shown) which receives the individual occupation information 302 via a communication network 208. The network interface and the communication network 208 may be the same or similar to the network interface 114 and the network 122 as described with respect to FIG. 1, respectively. The individual occupation information 302 may be received from a terminal device 210, for example. The terminal device 210 may be operated by the individual and the same or similar to the additional computer device 120 of FIG. 1. Additionally or alternatively, the individual occupation information 302 may be received from one or more databases 212(1) . . . (n). While the databases 212(1) . . . (n) are shown in FIG. 2 as being separate from the system 202, the system 202 may include any one or all of the databases 212(1) . . . (n) from which the individual occupation information 302 is obtained. The databases 212(1) . . . (n) may be the same or similar to the memory 106 as described with respect to FIG. 1, or the same or similar to any databases as generally known and understood in the art.

As described above, the individual may be any person or persons having any preexisting, new, or other relationship with the system 202, directly or indirectly. For example, the individual may be an employee of an employer, with the employer comprising, controlling, or otherwise operating the system 202. Alternatively, the employer may associate with another entity that compromises, controls, or otherwise operates the system 202.

Accordingly, while various embodiments are described herein as providing the individual with at least one option for relocation based at least in part on the individual occupation information 302, the options may be for relocation within the employer by which the individual is currently employed. The individual may desire or otherwise be seeking a new position within such current employer, and the option for relocation may be provided based on positions within the employer. Such positions may be openings within the employer, or the positions may include any other options for employment. The positions may include, for example, lateral transfers, promotions, or demotions. Of course, the positions which are searched herein for the options for relocation may be searched, filtered, or otherwise limited based on such criteria. The criteria may be selected by the individual, the employer, the above-mentioned other entity, or any other thing described herein.

Thus, as will be discussed in more detail herein, the individual occupation information 302 is obtained by the system 202 for determining at least one new career opportunity for the individual based at least in part on the individual occupation information 302. Any set or subset of positions or openings which correspond to the individual occupation information 302 may be used to determine the career opportunities. For example, the set or subset of positions or openings may be from the individual's current employer. Alternatively, the positions or openings may be determined from any public or private database. In this regard, such positions or openings may be limited to being from within any particular or otherwise specified employer, industry, agency, or field. Of course, these examples are merely exemplary and are not limiting or exhaustive. The set or subset of positions or openings from which the individual's career opportunities are determined may be derived in accordance with any criteria without departing from the scope of the present disclosure. Moreover, the set or subset of positions or opening may be filtered or otherwise modified by the individual, the system 202, and/or any additional entity described herein within departing from the scope of the present disclosure.

Further, while the above-described examples generally have the individual in an employee-employer relationship, it is to be known and understood that such relationship is merely exemplary and that the individual may be included in other or no relationships without departing from the scope of the present disclosure. In additional or alternative embodiments, the individual may be, for example, an agent, volunteer, intern, clerk, franchisee, owner, contractor, worker, freelancer, etc. The embodiments described herein may be directly or indirectly involved in any of such relationships, such that the positions or openings from which the career opportunities are determined may be directly or indirectly involved in any of such relationships. Additionally or alternatively, the positions or openings may be outside the scope of any of such relationships. That is, as mentioned above, the positions or openings may be searched or determined from any public or private database which is maintained independently of the individual and his or her current employment.

Even further, and as generally alluded to above, the terms positions and openings are merely exemplary and are not to be interpreted as limiting or exhaustive. The individual occupation information 302 may be searched against or matched with any vacant or desirable offerings without departing from the scope of the present disclosure.

In view of the above, the individual occupation information 302 may correspond to or include at least one of a primary occupation of the individual, an employment history of the individual, or an education of the individual. The primary occupation of the individual may relate to a current occupation of the individual, a current position held by the individual, a field of occupation of the individual, an occupational title of the individual, or any additional information related to a current or otherwise desired occupation or position of the individual. In this regard, neither the term primary nor the term occupation is intended to be limiting. That is, the term primary need not necessarily refer to a current or most significant occupation, but rather, may refer to any desired or otherwise intended occupation. Also, the term occupation need not necessarily refer to a profession, but rather, may refer to any line of work.

The individual occupation information 302 may additionally or alternatively include an employment history of the individual and/or an education of the individual. The individual occupation information 302 is intended to encompass any information which may be useful in matching or otherwise finding an opening, position, or career opportunity for the individual. Such employment history and education may include any information which is generally known and understood in the art.

The individual occupation information 302 may be obtained directly or indirectly from the individual. For example, the individual occupation information 302 may be obtained via the communication network 208 and/or the terminal device 210 by the individual submitting his or her resume or related information. Of course, the individual may provide the individual occupation information 302 in accordance with any additional or alternative methods which are generally known and understood in the art. Alternatively, the individual occupation information 302 may be obtained independently of the individual. For example, in embodiments in which a relationship exists between the system 202 and the individual, including those in which the individual is seeking a new position, opening, or career opportunity with a current employer, the individual occupation information 302 may be obtained without input of the individual. For example, the individual occupation information 302 may be obtained via one of the databases 212(1) . . . (n) which is maintained by or corresponds to the employer. In these embodiments, the individual occupation information 302 may comprise a resume of the individual, information from an employee profile of the individual, or any additional information which is generally known and understood in the art.

In addition to obtaining the individual occupation information 302, the operations include the processor 204 obtaining individual preference information 304. The individual preference information 304 may be obtained in the same or similar manners as described above with respect to the individual occupation information 302, or in accordance with any additional or alternative methods which are generally known and understood. The individual preference information 304 corresponds to at least one lifestyle preference of the individual. Such lifestyle preference may include a preference as to geographic location, nature of location, cost of living, education, area outlook, housing, weather, and/or any additional or alternative type of lifestyle preference. The individual preference information 304 may include selections or priorities of any of the above-mentioned lifestyle preferences, or types thereof. The individual preference information 304 may be obtained based on selections or settings made by the individual, or the individual preference information 304 may be obtained from a profile of the individual. In any event, the individual preference information 304 comprises lifestyle preferences which are obtained by the processor 204 in similarity to any of the methods described herein for obtaining the individual occupation information 302, or in accordance with any additional or alternative methods which are generally known and understood in the art.

The processor 204 further obtains current location information 306 from at least one predetermined source. The predetermined source may include any of the databases 212(1) . . . (n). The current location information 306 generally includes first information which corresponds to a plurality of locations. The first information further includes lifestyle measurements or evaluations for the locations. For example, the first information may indicate a setting or measurement regarding the geographic location, nature of location, cost of living, education, area outlook, housing, weather, and/or any additional or alternative type of lifestyle criteria at each of the locations. The settings or measurements preferably corresponding to the lifestyle preferences, or settings thereof, which are obtained in relation to the individual. The first information may be obtained from private, public, national, or governmental databases such as, but not limited to, the U.S. Census Bureau, the U.S. Bureau of Labor Statistics, the Federal Bureau of Investigation, and/or any other source.

The current location information 306 also includes second information which corresponds to openings, positions, or career opportunities, with such second information also being associated with their locations. The locations of the openings, positions, or career opportunities of the second information may correspond to the locations of the first information. The second information may also be obtained from any private, public, national, or governmental databases including those mentioned above as well as any additional databases which are generally known in the art for providing openings, positions, or career opportunities as discussed herein. Those skilled in the art will appreciate that any source may be useable for obtaining the current location information 306 without departing from the scope of the present disclosure.

While the current location information 306 is described as being current, it is to be known and understood that the term current does not require immediacy of the information. The term current as used in the current location information 306 may correspond to most-recent-available information, information collected within a predetermined time period, or newest information. Of course, the current location information 306 may additionally or alternatively include any additional or alternative information which corresponds to the plurality of locations which may or may not be current without departing from the scope of the present disclosure. In certain embodiments, the current location information 306 merely corresponds to the lifestyle preferences of the locations without regards to the information being current. In other words, the current location information 306 may merely require that the positions, openings, or career opportunities be current.

The processor 204 correlates the individual occupation information 302 and the individual preference information 304 with the current location information 306. Specifically, as shown in FIG. 3, the processor 204 may initially and separately correlate each of the individual occupation information 302 and the individual preference information 304 with the current location information 306. That is, the processor 204 may correlate the individual occupation information 302 with the current location information 306 to determine at least one matching position or opening (or also career opportunity) 308 for which the individual is qualified. In other words, the processor 204 correlates the primary occupation of the individual, the employment history of the individual, and/or the education of the individual to determine a position or opening for which the individual is qualified. The at least one matching position or opening 308 is described hereinafter in plural form for convenience. Nevertheless, it is to be known and understood that the singular and plural forms may be used interchangeably.

The matching positions or openings 308 may be determined using natural language processing or in accordance with any other methods which are known and understood in the art. The matching positions or openings 308 may be determined such that the individual is at least qualified thereof based on the individual occupation information 302 of the individual, such as the resume or profile information of the individual. In additional or alternative embodiments which will be described hereinafter, the matching positions or openings 308 may be determined such that the individual is under-qualified thereof based on the individual occupation information 302 of the individual. Nevertheless, the processor 204 correlates the individual occupation information 302 with the current location information 306 to determine the matching positions or openings 308. Each of the matching positions or openings 308 is associated with at least one location.

The processor 204 may, thereafter, compute a score 310 for each of the matching positions or openings 308. The score 310, hereinafter referred to as a profile score 310, may be computed based on any predetermined algorithm or formula and may include a numerical value and/or percentage. Of course, the profile match 310 may be computed in accordance with any additional or alternative method which is known and understood in the art, and may also include any additional or alternative quantifier which is generally known and understood in the art. The profile score 310 represents a match or similarity between the individual occupation information 302 of the individual and the matching positions or openings 308. The profile scores 310 may be stored or presented in correspondence with the matching positions or openings 308, or the profile scores 310 may be stored or presented in correspondence with the locations of the matching positions or openings 308. In the latter embodiments, readability and interpretability may be improved for the individual. Such non-limiting and advantageous effects will become apparent from the following descriptions.

When the processor 204 separately correlates the individual occupation information 302 with the current location information 306 to determine the matching positions or openings 308 for which the individual is qualified and the profile scores 310 thereof, the processor 204 may further separately correlate the individual preference information 304 with the current location information 306 to determine matching lifestyle locations 312. For example, the processor 204 may normalize values of the lifestyle preferences of the individual and the lifestyle measurements or evaluations of the locations included within the current location information 306. As a result, the processor 204 is able to determine locations which correspond to the lifestyle preferences of the individual. That is, if the individual prefers locations with warm weather and low crime, the processor 204 is able to determine such areas from the current location information 306. The matching lifestyle locations 312 may correspond to those locations for which the matching positions or openings 308 are determined, or the matching lifestyle locations 312 may include any subset of the locations for which the matching positions or openings 308 are determined. Further, the matching lifestyle locations 312 may include locations which do not correspond to the matching positions or openings 308.

The processor 204 further correlates the individual preference information 304 with the current location information 306 to determine or compute a score 314 for each of the matching lifestyle locations 312. The score 314, hereinafter referred to as a lifestyle score 314, may be computed based on any predetermined algorithm or formula and may include a numerical value and/or percentage. Of course, the lifestyle score 314 may be computed in accordance with any additional or alternative method which is known and understood in the art, and may also include any additional or alternative quantifier which is generally known and understood in the art.

While the embodiments described above and shown in FIG. 3 generally include the individual occupation information 302 and the individual preference information 304 being separately and independently correlated with the current location information 306 to determine the profile score 310 and the lifestyle score 314, additional embodiments of the present disclosure include the individual occupation information 302 and the individual preference information 304 being correlated first with each other and then with the current location information 306. In this regard, the individual occupation information 302 and the individual preference information 304 may be correlated with each other and then with the current location information 306 in accordance with any predetermined algorithms, formulas, or other methods which are generally known and understood in the art. In even further additional embodiments, the individual occupation information 302 and the individual preference information 304 may be correlated with the current location information 306 at a same time or alternately. For example, the individual preference information 304 may be correlated with the current location information 306 to determine desirable locations and/or undesirable locations, the individual occupation information 302 may then be correlated with the current location information 306 to determine the profile score 310 for any of the matching positions or openings 308 (and/or locations thereof) in the desirable locations and/or to exclude the profile score 310 for any of the matching positions or openings 308 (and/or locations thereof) in the undesirable locations. Thereafter, the individual preference information 304 may be correlated with the current location information 306 to determine the lifestyle score 314 for each location of the matching positions or openings 308. According to such embodiment, processing time and/or power for computing the profile score(s) 310 and the lifestyle score(s) 314 may be reduced by including only those desirable locations and/or by excluding undesirable locations. Of course, the above-described examples are merely exemplary and are not limiting or exhaustive. The individual occupation information 302 and the individual preference information 304 may be correlated with the current location information 306 in accordance with any additional or alternative methods without departing from the scope of the present disclosure.

After correlating the individual occupation information 302 and the individual preference information 304 with the current location information 306, the operations further include the processor 204 determining, based on the correlating, at least one location as at least one option for relocation. Such at least one location is referred to hereinafter as a relocation option for convenience. Further, the relocation option is referred to hereinafter in plural form for convenience. Nevertheless, it is to be known and understood that the singular and plural forms may be used interchangeably.

The relocation options are determined by combining the profile score 310 for any of the matching positions or openings 308 (and/or locations thereof) and the lifestyle scores 314 for the corresponding locations. The profile scores 310 and the lifestyle scores 314 may be combined by addition, averaging, or by any other method known and understood in the art. The profile scores 310 and the lifestyle scores 314 may be combined with equal weighting, or any of the profile scores 310 and the lifestyle scores 314 may be weighted by the individual or the system 202. In any event, the locations which have a highest combined score may be determined to be the relocation options. In this regard, it should be understood that the profile scores 310 and the lifestyle scores 314 may be combined in any known and understood manner to determine the relocation options.

The processor 204 may provide the relocation options to the individual. The relocation options may be provided such as by being displayed on a display of the terminal device 210, for example. The display of the terminal device 210 may be the same or similar to the display 108 of FIG. 1. Of course, the relocation options may be provided to the user in additional or alternative forms without departing from the scope of the present disclosure. Detailed embodiments by which the relocation options are provided to the individual are described below.

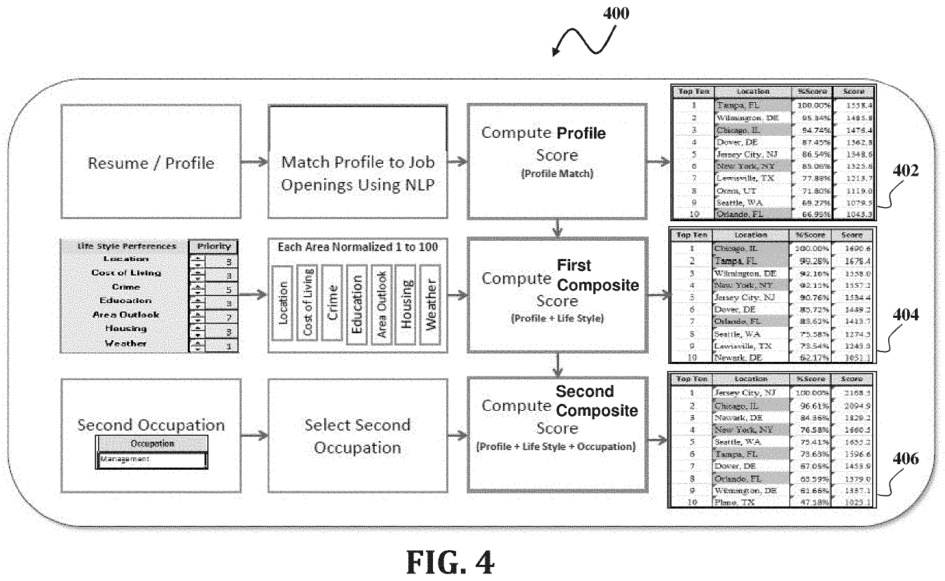

The processor 204 may also provide the matching positions or openings 308 (and/or locations thereof) for which the profile scores 310 are computed to the individual. For example, a non-limiting and exemplary schematic for providing the relocation options together with the profile scores 310 to the individual is generally shown in FIG. 4 at 400.

In the embodiment shown in FIG. 4, for example, the locations of the matching positions or openings 308 for which the profile scores 310 are computed are provided to the user as profile matches 316 in display 402.

Thereafter, the profile scores 310 may be combined with the locations for which the lifestyle scores 314 are computed to provide the user with a first composite score of (profile+lifestyle) matches 318. That is, as shown in FIG. 3, the processor 204 generally updates the profile matches 316 based on the lifestyle scores 314 to provide the (profile+lifestyle) matches 318 without providing the user with lifestyle matches (not shown). Such (profile+lifestyle) matches 318 are provided to the individual in display 404 of FIG. 4. According to such embodiment, processing and display requirements of the system 202 may be reduced by not displaying the lifestyle matches.

In embodiments of the present disclosure in which only the profile scores 310 and the lifestyle scores 314 are computed, the (profile+lifestyle) matches 318 may be the relocation options which are provided to the individual. Such relocation options may be provided to the individual in any format which is generally known and understood in the art including, for example, a list format as generally shown in the display 404 of FIG. 4. The list format be provided in ascending, descending, or any additional format. For example, also as generally shown in the display 404 of FIG. 4, the relocation options, e.g., the (profile+lifestyle) matches 318, may be ranked based on their composite score(s). The relocation options may be ranked in accordance with any known and understood methods, and any number of relocation options may be provided to the individual based on any predetermined criteria. For example, those relocation options which have a composite score that exceeds a predetermined threshold may be provided to the individual, or a predetermined number of relocation options having a highest composite score may be provided to the individual. Of course, these examples are merely exemplary and are not limiting or exhaustive.

Accordingly, in the above-described example and as generally shown in FIG. 3 and FIG. 4 in-part, the system 202 provides relocation options to the individual based on correlating the individual occupation information 302 and the individual preference information 304 with the current location information 306. As a result, the system 202 provides a single source which balances career planning and familial desires. While the above-described example includes the profile matches 316 and the (profile+lifestyle) matches 318 being provided to the individual, additional examples include the lifestyle matches (not shown) and the (profile+lifestyle) matches 318 being provided to the individual. Further, in even additional examples, the profile matches 316, the lifestyle matches (not shown), and the (profile+lifestyle) matches 318 may be provided to the individual.

In further embodiments of the present disclosure, the system 202 further provides the relocation options to the individual based on a secondary occupation. As will be described below, the second occupation may be for a second individual different than the first individual, or the second occupation may be for a second occupation of the individual. As a result, the system 202 may further provide the relocation options for a family or other group of persons with two working individuals, or the system may provide the relocation options for an individual, or family thereof, that works multiple jobs. Accordingly, the system provides a further single source that balances career planning and familial desires for unique or specific families, or other groups of persons.

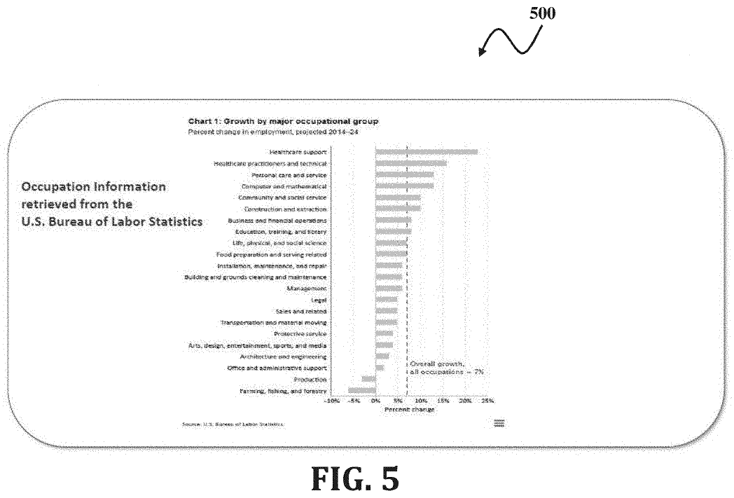

In the further embodiments, the operations further include the processor 204 obtaining second occupation information 320. The second occupation information 320 may correspond to at least one of an occupation of a second individual, an employment history of the second individual, or an education of the second individual. In this regard, the second occupation information 320 may be the same or similar to the individual occupation information 302 as described above. That is, the second occupation information 320 may include a resume or profile of the second individual. Alternatively, the second occupation information 320 may comprise a more general job search and include a selection of a type of occupation. The selection may be made from, for example, occupational groupings. A non-limiting and exemplary embodiment of occupational groupings, as provided by the U.S. Bureau of Labor Statistics, is generally shown by FIG. 5 at 500. Of course, these groupings are merely exemplary and are not limiting or exhaustive. The selection may be made from, for example, a drop-down menu. Accordingly, the second occupation information 320 corresponds to a second individual that may be different than the individual to which the individual occupation information 302 corresponds. Further, the second occupation information 320 may be specific to the second individual similar to the manner in which the individual occupation information 302 is specific to the individual, or the second occupation information 320 may comprise a more general category, type, or filed of occupation. In any event, the processor 204 receives the second occupation information 320.

The processor 204 may further correlate the second occupation information 320 with the current location information 306 to determine the relocation options. In other words, the processor 204 may correlate the individual occupation information 302, the individual preference information 304, and the second occupation information 320 with the current location information 306 to determine the relocation options. Such correlation may be performed in accordance with any of the above-described methods. That is, the processor 204 may individually and separately correlate each of the individual occupation information 302, the individual preference information 304, and the second occupation information 320 with the current location information 306. Alternatively, the individual occupation information 302, the individual preference information 304, and the second occupation information 320 may be correlated with each other and then with the current location information 306, or the individual occupation information 302, the individual preference information 304, and the second occupation information 320 may be correlated with the current location information 306 at a same time or alternately. Again, such correlations may be in accordance with any predetermined algorithms, formulas, or other methods which are generally known and understood in the art. Nevertheless, the processor 204 may further determine, based on the correlation(s) including the second occupation information 320, matching second positions or openings 322, and locations thereof, which correspond to the second occupation information 320.

The processor 204 further correlates the second occupation information 320 with the current location information 306 to determine or compute a score 324 for each of the matching second positions or openings 322 (and/or locations thereof). The score 324, hereinafter referred to as an occupation score 324, may be computed based on any predetermined algorithm or formula and may include a numerical value and/or percentage. Of course, the occupation score 324 may be computed in accordance with any additional or alternative method which is known and understood in the art, and may also include any additional or alternative quantifier which is generally known and understood in the art.

In the above-embodiment, after correlating the individual occupation information 302, the individual preference information 304, and the second occupation information 320 with the current location information 306, the processor 204 determines, based on the correlating, the relocation options. The relocation options may be determined by combining the profile score 310 for any of the matching positions or openings 308 (and/or locations thereof) which correspond to the individual occupation information 302, the lifestyle scores 314 for the locations which correspond to the individual preference information 304, and the occupation score 324 for any of the matching second positions or openings 322 (and/or locations thereof) which correspond to the second occupation information 320. Such scores 310, 314, and 324 may again be combined by addition, averaging, or by any other method known and understood in the art. The scores 310, 314, and 324 may further be combined with equal weighting, or any of the scores 310, 314, and 324 may be weighted by the individual or the system 202.

The processor 204 may provide the relocation options to the individual. The relocation options may again be provided such as by being displayed on the display of the terminal device 210, for example. A detailed example by which the relocation options are provided to the individual is again described below.

For example, in addition to providing the profile matches 314 and the first composite score of the (profile+lifestyle) matches 318 as described in the above example, the processor 204 generally updates the (profile+lifestyle) matches 318 based on the occupation scores 324 to provide (profile+lifestyle+occupation) matches 324 without providing the user with occupation matches (not shown). Such (profile+lifestyle+occupation) matches 324 are provided to the individual in display 406 of FIG. 4. According to such embodiment, processing and display requirements of the system 202 may again be reduced by not displaying the lifestyle matches and the occupation matches. Of course, in further embodiments, the lifestyle matches and/or the occupation matches may be provided to the individual.

In such embodiments of the present disclosure in which the profile scores 310, the lifestyle scores 314, and the occupation scores 324 are computed, the (profile+lifestyle+occupation) matches 326 may be the relocation options which are provided to the individual. Such relocation options may be provided to the individual in accordance with any of the above-described formats and manners including, for example, a list format as generally shown in the display 406 of FIG. 4.

Accordingly, in the above-described example and as generally shown in FIG. 3 and FIG. 4, the system 202 provides relocation options to the individual based on correlating the individual occupation information 302, the individual preference information 304, and the second occupation information 320 with the current location information 306. As a result, the system 202 provides a single source which balances career planning for plural individuals and also familial desires.

In a further embodiment of the present disclosure in which the individual occupation information 302, the individual preference information 304, and the second occupation information 320 are correlated with the current location information 306, the individual may be associated with an entity. For example, the individual may be an employee of an employer. These terms are used hereinafter in the instant described embodiment for clarity and convenience. Nevertheless, it is again to be known and understood that these terms are merely exemplary and that additional or alternative relationships or associations may exist between the individual and the entity. In any event, the second individual may be unassociated, or not associated, with the employer (or other entity).

The at least one source, from which the current location information 306 is obtained, may include a first database of the employer. The first database may comprise one of the databases 112(1) . . . (n). The first database may include first position information 328 associated with the employer throughout a plurality of locations. In other words, the first database may include information on positions or openings for the employer throughout its locations. The current location information 306 may include or comprise the first position information 328, e.g., the information on the positions or openings for the employer. In the correlating, the individual occupation information 302 of the employee may be correlated with the first position information 328 of the employer. In other words, the individual occupation information 302 of the employee may be correlated with the first position information 328 of the employer to determine available positions or openings of the employer for which the individual is a match.

In such embodiments, the individual occupation information 302 may include a resume or profile of the employee, which may be stored by the employer in the first database. As a result, the employer may automatically determine positions or openings for which the employee is qualified or for which the employee matches without intervention of the employee. Further, the second occupation information 320 of the second individual which is not associated with the employer may not be correlated with the first position information 328 of the employer. In other words, since the second individual is not employed by the employer, the positions or openings of the employer are not searched for the second individual.

Instead, the databases 112(1) . . . (n) from which the current location information 306 is obtained may further include a second database unassociated with the employer. The second database may include second position information 330 unassociated with the employer. Instead, the second position information 330 may comprise public job positions, postings, or openings as described herein. Additionally or alternatively, the second database may comprise general occupational information. For example, the second database may include availability or growth of particular occupations in particular regions, such that the relocation options may account for the second occupation information 320 generally. In other words, the system 202 may account for general job availability at the relocation options without accounting for specific openings or positions. In this regard, in the correlating, the second occupation information 320 is correlated with the second position information 330 with the individual occupation information 302 not being correlated with the second position information 330.

Accordingly, in such above-described embodiment, positions or openings within the employer, which employs the individual, may be searched and correlated with the individual occupation information 302. As a result, the individual may search for transfer locations within the same employer. The transfer locations may be in a more desirable or preferred location, or the openings or positions at such locations may be more desirable to the individual. Nevertheless, a second individual in the employee's family, for example, may also account for his or her career interests in determining the relocation options, while also accounting for the familial desires.

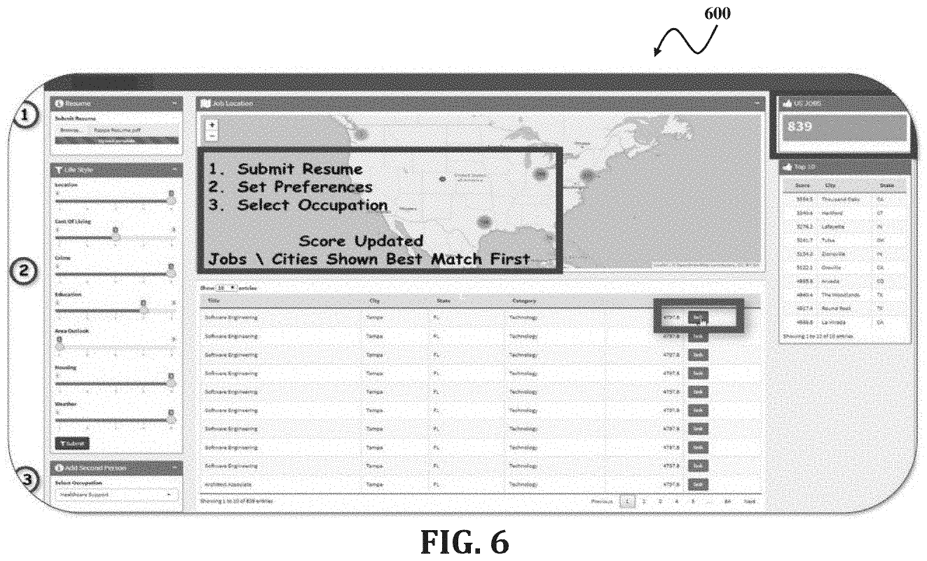

In the above-described embodiments, the system 202 is generally described as searching for the matching positions or openings 308 based on the individual occupation information 302. However, in further embodiments, a selection of an occupation may be received from the individual. In this regard, the current location information 306 may be searched for the matching positions or openings 308 based on the selected occupation, while using the individual occupation information 302 as qualifications for the matching positions or openings 308. For example, the matching positions or openings 308 may be searched for based on the selected occupation using natural language processing. In this regard, in such embodiments as well as any of the additional embodiments described herein, the profile matches 316 which include the positions or openings 308 (and/or the locations thereof) which correspond to the selected occupation of the individual may be provided to the individual together with links to the positions or openings 308 (and/or the locations thereof). A non-limiting and exemplary embodiment of a display 600 which includes links for the positions or openings 308 (and/or the locations thereof) is shown by FIG. 6.

In even further embodiments of the present disclosure in which the individual is associated with an entity, the predetermined source from which the current location information 306 is obtained may include a database of the entity. In this regard, the entity is again described as an employer and the individual as an employee for convenience and clarity. Nevertheless, it is again to be known and understood that such terms are merely exemplary and that additional or alternative relationships or associations may exist between the individual and the entity. The predetermined source may be a database of the employer, such as one of the databases 112(1) . . . (n). The first database may include the first position information 328 associated with the employer throughout a plurality of locations, as generally described in the preceding embodiments. Further, the current location information 306 may also include the first position information 328, as again generally described in the preceding embodiments. Accordingly, the individual occupation information 302 of the employee may be correlated with the first position information 328 of the employer to determine available positions or openings of the employer for which the employee is a match. Such features provide the non-limiting and advantageous effects of enabling the employee to relocate to a more desirable location within the employer and/or to a more desirable position. Further, the employer is provided with the non-limiting and advantageous effects of being able to easily and appropriately fill vacancies from within.

With respect to the latter non-limiting and advantageous effect for the employer which was mentioned in the preceding paragraph, further embodiments of the present disclosure are provided which even further enhance such non-limiting and advantageous effects.

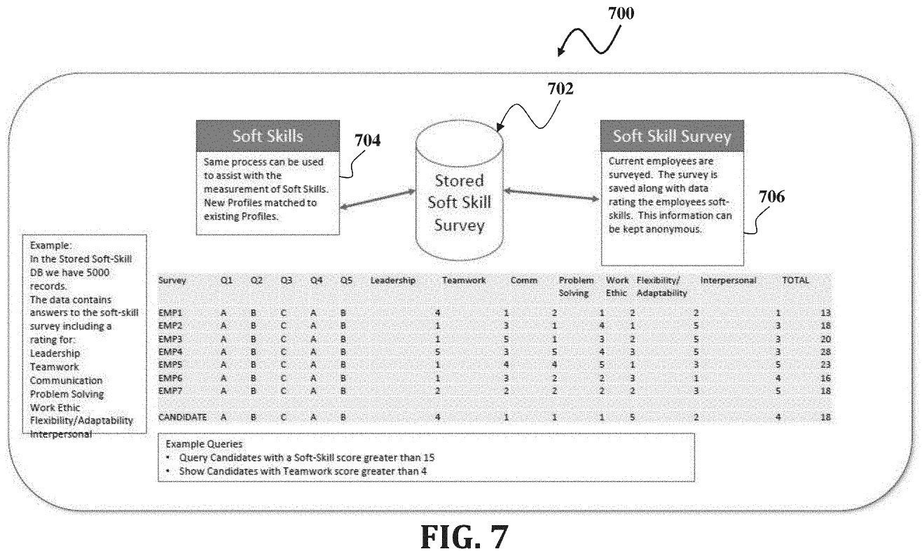

According to a first one of such embodiments, the employer may conduct a skills comparison with other employees to determine whether the employee is likely to succeed at one of the openings or positions 308. A non-limiting and exemplary embodiment of such skills comparison is generally shown in FIG. 7 at 700. The skills comparison 700 relates to information stored in a skills database 702.

According to the skills comparison 700, the processor 204 may obtain first skill information 704 of the employee. The first skill information 704 may include an evaluation of at least one skill of the employee. The evaluation may be conducted or made by the employer. In this regard, the evaluation and the skill may be stored in the skills database 702. The skills database 702 may be, or be included within, the database of the employer, which may be one of the databases 112(1) . . . (n). The skills may include, for example, quarterly performance, overall performance, leadership, teamwork, communication, problem solving, work ethic, flexibility/adaptability, interpersonal skills, a cumulative score, and/or any additional skills which are known and understood in the art. In this regard, the skills may comprise soft skills but are not limited thereto.

The processor 204 may obtain second skill information 706 of a plurality of other employees. The second skill information 706 may comprise skill survey information and include, for the other employees, an evaluation of the at least one skill which is made for the employee. The processor 204 may correlate the first skill information 704 of the employee with the second skill information 706 of the other employees to determine whether the employee (i.e., individual) will be successful at the positions or openings of the employer. Such positions or openings of the employer may be included in the first position information 328, which is included in the current location information 306.

In this regard, in embodiments of the present disclosure, the positions or openings of the employer which are included in the first position information 328 may be filtered or otherwise limited based on determinations of whether the individual is likely to succeed at such positions or openings. The positions or openings may be filtered or otherwise limited in accordance with any known and understood methods without departing from the scope of the present disclosure. Accordingly, the processor 204 may determine or obtain the first position information 328, which is included in the current location information 306, based on a likelihood of whether or not the employee will be successful at the positions or openings included within the first position information 328. As a result, positions or openings for which the employee may not be successful may be excluded or otherwise limited from the matching positions or openings 308. As a result, processing requirements of the system 202 are reduced. Further, the employer is able to more efficiently and correctly fill the vacancies therein.

In further embodiments of the present disclosure, the positions or openings of the employer which are included in the first position information 328 may be weighted based on determinations of whether the individual is likely to succeed at such positions or openings. The positions or openings may be weighted in accordance with any known and understood methods without departing from the scope of the present disclosure. Accordingly, when the individual occupation information 302 is correlated with the first position information 328, the profile scores 310 for the matching positions or openings 308 may reflect the determinations. As a result, the system 202 may discourage or otherwise reflect a likelihood of success at a relocation position to the employee.

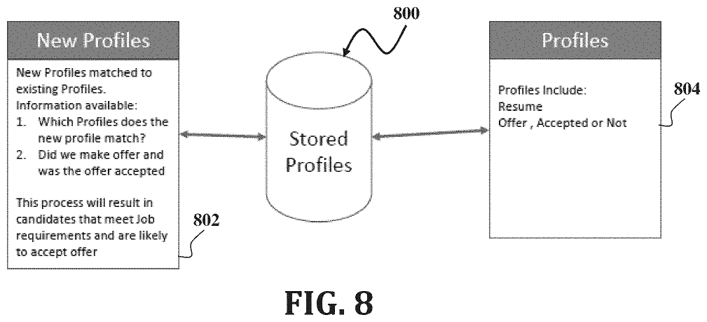

According to a second one of the embodiments in which the employer is provided with the non-limiting and advantageous effects of being able to easily and appropriately fill vacancies from within, the employer may conduct a profile comparison with other employees to determine whether the employee is likely to accept one of the openings or positions 308. Such a profile comparison may utilize a profile database 800, which is generally indicated in FIG. 8. The profile database 800 may be, or be included within, the database of the employer, which may be one of the databases 112(1) . . . (n).

In such second one of the embodiments, the processor 204 may obtain first profile information 802 of the employee from the profile database 800. The first profile information 802 may be considered a new profile, as it relates to vacant positions or openings of the employer. The first profile information 802 may include any information of the individual occupation information 302 or the individual preference information 304 as discussed herein. The processor 204 may further obtain second profile information 804 of a plurality of other employees. The second profile information 804 may include similar information as the first second profile information 804, and also includes information about whether the employees accepted or rejected positions or openings of the employer. The processor 204 may correlate the first profile information 802 with the second profile information 804 to matches between the employee and the other employees. Based on the matches, the processor may determine a likelihood of whether the employee will accept or reject the positions or openings of the employer. The positions or openings of the employer which are included in the first position information 328, which is included in the current location information 306, may be obtained based on the correlating of the first profile information with the second profile information. In other words, the positions or openings of the employer which are included in the first position information 328 may be determined based matches between the profiles of the employee and the other employees and/or a likelihood of the employee accepting or rejecting the positions or openings. As a result, positions or openings for which the employee may be likely to accept or reject may be included or excluded from the first position information 328 of the current location information 306. As a result, the employer is able to more efficiently and predictably fill the vacancies therein.

According to a third one of the embodiments in which the employer is provided with the non-limiting and advantageous effects of being able to easily and appropriately fill vacancies from within, and also in which the employer is able to provide the non-limiting and advantageous effect of encouraging growth of employees, the employer may provide a roadmap to such employees for such growth. Specifically, the processor 204 may compare the individual occupation information 302 with the first position information 328 of the current location information 306 to determine shortcomings of the individual occupation information 302 for positions or openings in the first position information 328. In other words, the first position information 328 may include positions or openings for which the employee is under-qualified, and such positions or openings may be included within the matching positions or openings 308. Such under-qualified positions or openings may be eligible to be included within the matching positions or openings 308 when they are within a predetermined level or criteria of being satisfied by or corresponding to the individual occupation information 302. For example, the under-qualified positions or openings may be eligible to be included when they require a predetermined number of raises or increases in clearance or security level, a predetermined number of hours of course or other work, a predetermined time of experience, or any other criteria which is generally known and understood in the art. Of course, these examples are merely exemplary and are not limiting or exhaustive.

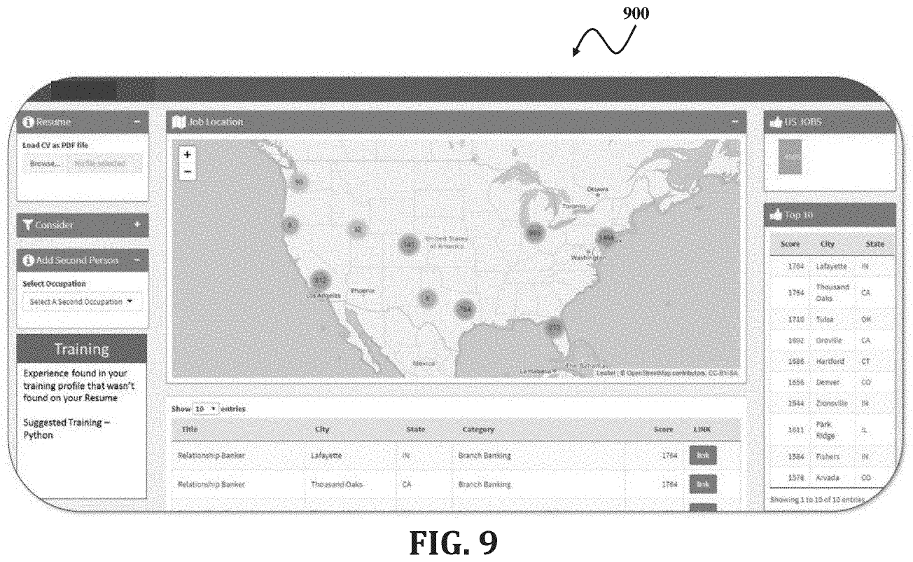

In an event that the under-qualified positions or openings are included in the matching positions or openings 308, the processor 204 may determine, based on the individual occupation information 302, a roadmap for overcoming the shortcomings for the under-qualified matching positions or openings 308. In other words, the processor 204 may determine the criteria by which the individual occupation information 302 may be updated to qualify for the under-qualified positions or openings. The processor 204 may provide such roadmap and/or criteria to the employee in accordance with any of the methods described herein or as generally known and understood in the art. A non-limiting and exemplary display which includes a provision of such roadmap and/or criteria to the employee is shown in FIG. 9 at 900. In the display 900, it is suggested that the employee include training for Python. Of course, such display 900 is merely exemplary and not limiting or exhaustive. Accordingly, the employer may motivate and provide the employee with a path to a more desirable position or opening, and/or a more desirable location.

In the above-described embodiment, the roadmap for overcoming the shortcomings for the under-qualified positions or openings may be determined by accessing an employee profile of the individual such as, for example, the profile database 800 of FIG. 8. In this regard, the roadmap may be determined by comparing the first profile information 802 of the employee with the second profile information 804 of other employees which qualify for the positions or openings, for which the employee is under-qualified, to determine deficiencies of the individual occupation information 302 of the employee. Of course, the shortcomings or deficiencies of the first profile information 802 of the employee may be determined in accordance with additional and/or alternative methods which are generally known and understood in the art.

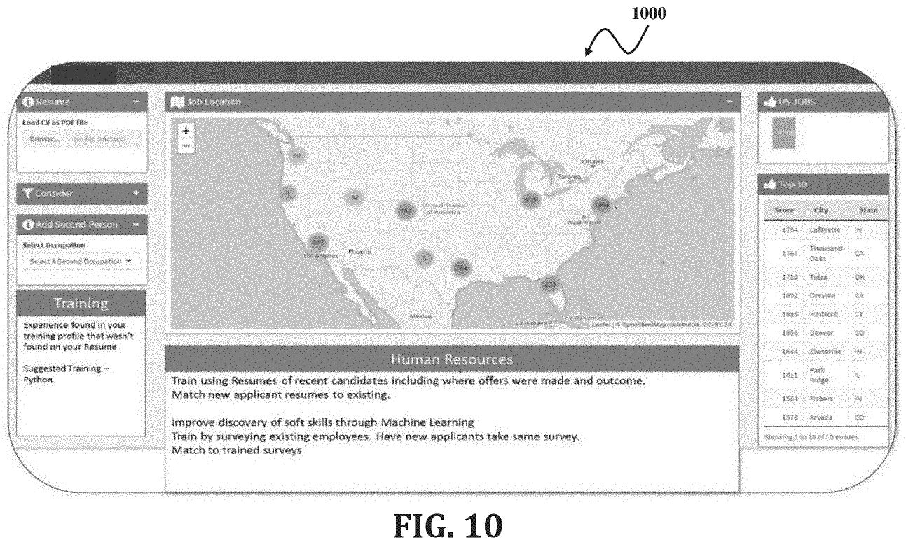

For example, the shortcomings or the deficiencies for the under-qualified positions or openings may be determined by accessing the skills database 702 of FIG. 7. In this regard, the roadmap may be determined by comparing the first skill information 704 of the employee with the second skill information 706 of other employees which qualify for the positions or openings, for which the employee is under-qualified, to determine deficiencies of the individual occupation information 302 of the employee. A non-limiting and exemplary display which includes a provision of such roadmap and/or criteria for the employee is shown in FIG. 10 at 1000. In the display 1000, it is suggested that the employee improve discover of skills through machine learning. Of course, such display 1000 is merely exemplary and not limiting or exhaustive.

In even further embodiments of the present disclosure in which the individual may be an employee of the employer, which may be provided in combination with or alternatively to the embodiments described above, the processor may automatically access an employee profile of the individual to obtain the individual occupation information 302. The employee profile may be accessed from, for example, the first profile information 802 of the profile database 800 of FIG. 8. Further, additionally or alternatively to such feature, the processor 204 may automatically access at least one of a social media platform, a financial record, a phone record, or a credit history of the individual to automatically obtain the individual preference information 304. Exemplary embodiments of such features and methods for automatically obtaining the individual preference information 304 are described below. According to these embodiments, the system 200 for providing the individual with the relocation options may be streamlined via automation.

In even further additional or alternative embodiments, the processor 204 may obtain at least a part of the individual preference information 304 by accessing a social media platform of the individual and identifying, as a lifestyle preference, locations of persons associated with the individual on the social media platform. For example, the processor 204 may access the social media platform to determine the locations of friends and/or family members of the individual. The processor 204 may consider only those friends and/or family members with which the individual frequently communicates, or those having posts which the individual frequently likes. The processor 204 may determine such frequency based on whether a predetermined number of interactions per predetermined time period exceeds a predetermined amount, or the processor 204 may determine such frequency based on whether a percentage of total communications or likes exceeds a predetermined threshold. Of course these examples are merely exemplary and are not limiting or exhaustive. The processor 204 may determine the locations of the persons in accordance with any additional or alternative means such as, but not limited to, a predetermined number of most frequently and/or most recently interacted with persons. In any event, the processor 204 may be able to automatically determine locations of interest to the individual. Further, the processor 204 may additionally or alternatively determine additional lifestyle preferences. The processor 204 may, for example, determine such additional lifestyle preferences in accordance with content or pictures at the social media platform. For example, if the individual frequently likes or dislikes warm or cold weather postings and/or has taken many photos in warm or cold climates, the processor 204 may set a lifestyle preference for a type of weather accordingly. Thus, the processor 204 is able to automatically determine, refine, or confirm the individual preference information 304, thereby improving accuracy of the system 202.

In further additional or alternative embodiments, the processor 204 may obtain at least a part of the individual occupation information 302 by accessing at least one of a social media platform or a networking platform of the individual and identifying locations of persons associated with the individual on the social media platform or the networking platform to determine locations of preference. In this regard, the persons may correspond to the individual as networking opportunities. According to such embodiment, the processor 204 may set the individual occupation information 302 to have a preference for locations in which the individual has existing networking opportunities. As a result, during the correlating of the individual occupation information 302 and the current location information 306, the processor 204 may favor, prefer, prioritize, or otherwise select openings or positions having locations in which the individual has existing networking opportunities as the matching openings or positions 308. Thus, the individual may be better prepared to further his career at such locations of the matching openings or positions 308.

In further additional or alternative embodiments, the processor 204 may obtain at least a part of the individual preference information 304 by accessing a phone record of a phone of the individual and identifying at least one of destinations of outgoing communications, originations of incoming communications, or locations corresponding to a positioning trace of the phone as a lifestyle preference. Accordingly, the processor 204 may set locations with which the individual as frequent contact, or characteristics of such locations, as the lifestyle preferences. In other words, the processor 204 may presume that the individual may prefer locations, or characteristics thereof, with which the individual frequently contacts. Again, the processor 204 may determine such frequency based on whether a predetermined number of communications and/or contacts per predetermined time period exceeds a predetermined amount, based on whether a percentage of total communications and/or contacts exceeds a predetermined threshold, based on whether a predetermined number of most frequent and/or most recent communications and/or contacts exceeds a predetermined amount, etc. In any event, the processor 204 is again able to automatically determine, refine, or confirm the individual preference information 304, thereby improving accuracy of the system 202.

In further additional or alternative embodiments, the processor 204 may obtain at least a part of the individual preference information 304 by accessing at least one of a financial record or a credit history of the individual and identifying at least one lifestyle preference of the individual based on the one of the financial record or the credit history. In this regard, the processor 204 may determine past places where the individual lived, made purchases, or is otherwise associated, or the characteristics of such places, as the lifestyle preference. The processor 204 my further consider areas or regions from which the individual made purchases, or the characteristics of such areas or regions, to determine the lifestyle preference. For example, if the individual frequently makes purchases from beach or country regions, the processor 204 may set a lifestyle preference for such regions. Additionally, the processor 204 may consider the specific businesses from which the individual makes purchases. For example, if the individual frequently makes purchases from hunting or outdoorsman stores, the processor 204 may further set a lifestyle preference accordingly. Of course, these examples are again merely exemplary. The processor 204 may automatically set any lifestyle preference(s) in accordance with any additional known and understood methods to further automate and improve the accuracy of the system 202.

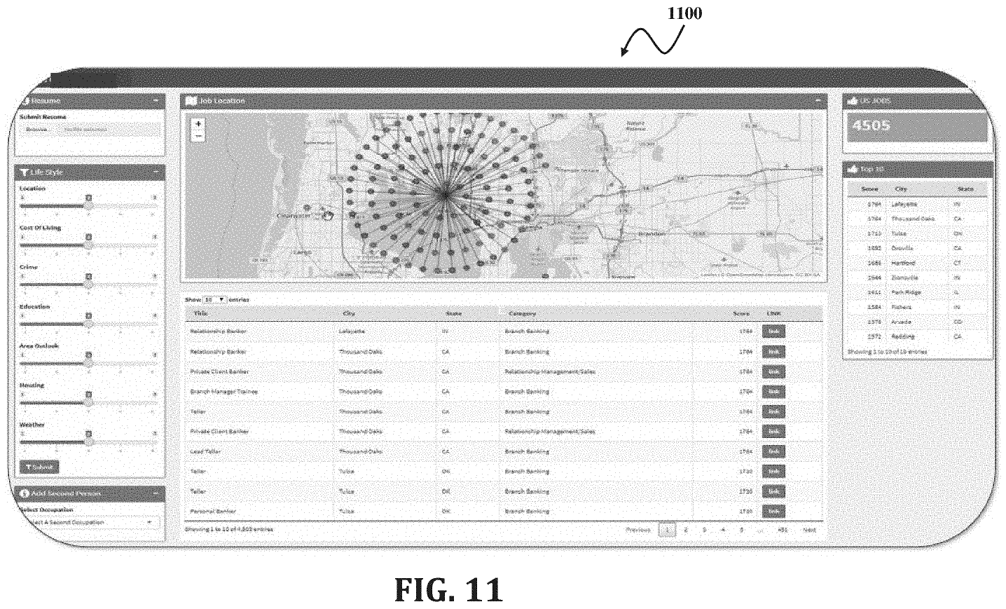

Finally, the relocation options may be provided to the individual in any format generally known and understood in the art. For example, the relocation options may be provided in list-format as previously discussed, or the relocation options may be provided in graphical format as generally shown in the display 1100 of FIG. 11

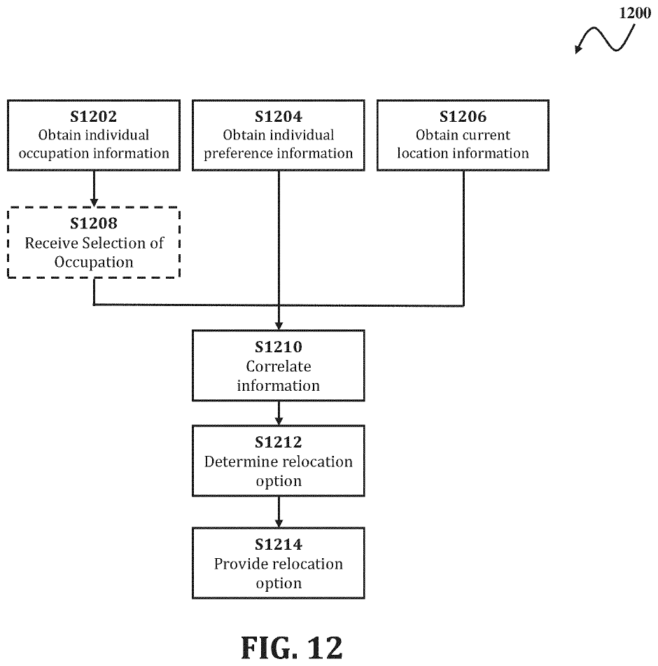

The present disclosure further provides various methods, programs, and media embodiments consistent with the above-described features. An exemplary method is generally shown in FIG. 12 at 1200. In the method 1200, individual occupation information is obtained at S1202. The individual occupation information corresponds to at least one of a primary occupation of the individual, an employment history of the individual, or an education of the individual. Individual preference information is obtained at S1204. The individual preference information corresponds to at least one lifestyle preference of the individual. Current location information is obtained from at least one predetermined source at S1206. The current location information corresponds to a plurality of locations. A selection of an occupation may be received at S1208. The individual occupation information, the individual preference information, and/or the selected occupation may be correlated with the current location information at S1210. From among the plurality of locations and based on the correlating, at least one location is determined as the at least one option for relocation at S1212. The at least one location is provided to the individual as the at least one option for relocation at S1214.

Accordingly, with this technology, a single source is provided to guide families, or individuals, looking to relocate as a result of a new career opportunity. The various aspects, embodiments, features, and/or sub-components distinguish between types of jobs available as well as provide a list of locations that fit lifestyle criteria or preferences. Accordingly, by the present disclosure, an informed, intelligent, and customizable relocation process is provided that balances career planning with familial desires.

Although the embodiments have been described with reference to several examples, it is understood that the words that have been used are words of description and illustration, rather than words of limitation. Changes may be made within the purview of the appended claims, as presently stated and as amended, without departing from the scope and spirit of the present disclosure in its aspects. Although the embodiments have been described with reference to particular means, materials and embodiments, the embodiments are not intended to be limited to the particulars disclosed; rather the embodiments extend to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present disclosure describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present disclosure may encompass software, firmware, and hardware implementations, or combinations thereof. Nothing in the present disclosure should be interpreted as being implemented or implementable solely with software and not hardware.

Although the present disclosure describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this disclosure to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A system for providing an individual with at least one option for relocation based on obtained information, the system comprising:
a processor; and
a memory including instructions that, when executed by the processor, cause the processor to perform operations including:
obtaining individual occupation information, the individual occupation information corresponding to at least one of a primary occupation of the individual, an employment history of the individual, or an education of the individual;
obtaining individual preference information, the individual preference information corresponding to at least one lifestyle preference of the individual;
obtaining current location information from at least one predetermined source, the current location information corresponding to a plurality of locations;
correlating the individual occupation information and the individual preference information with the current location information;
determining, from among the plurality of locations and based on the correlating, at least one location as the at least one option for relocation; and
providing the at least one location as the at least one option for relocation to the individual.

2. The system according to claim 1, wherein
the operations further include:
obtaining second occupation information, the second occupation information corresponding to at least one of an occupation of a second individual, an employment history of the second individual, or an education of the second individual, and
the correlating correlates the individual occupation information, the individual preference information, and the second occupation information with the current location information to determine the at least one location as the at least one option for relocation.

3. The system according to claim 2, wherein
the individual is associated with an entity,
the second individual is unassociated with the entity,
the at least one predetermined source, from which the current location information is obtained, includes a first database of the entity, the first database including first position information associated with the entity throughout the plurality of locations, the current location information including the first position information,
in the correlating, the individual occupation information is correlated with the first position information of the entity and the second occupation information is not correlated with the first position information of the entity,
the at least one predetermined source, from which the current location information is obtained, further includes a second database unassociated with the entity, the second database including second position information unassociated with the entity throughout the plurality of locations, the current location information further including the second position information, and
in the correlating, the second occupation information is correlated with the second position information and the individual occupation information is not correlated with the second position information.

4. The system according to claim 2, wherein the operations further include:
computing, based on the correlating and for the at least one location, a plurality of scores, the plurality of scores including:
a profile score corresponding to a match between the at least one location and the individual occupation information;
a lifestyle score corresponding to a match between the at least one location and the individual preference information; and
an occupation score corresponding to a match between the at least one location and the second occupation information; and
providing, to the individual: the profile score; a first composite score of the profile score and the lifestyle score; and a second composite score of the profile score, the lifestyle score, and the occupation score.

5. The system according to claim 1, wherein
the operations further include:
obtaining second occupation information, the second occupation information corresponding to a secondary occupation of the individual, the secondary occupation being different than the primary occupation, and
the correlating correlates the individual preference information, the individual occupation information, and the second occupation information with the current location information to determine the at least one location as the at least one option for relocation.

6. The system according to claim 1, wherein
the operations further include:
receiving a selection of an occupation for the individual, and
the correlating includes searching the current location information using the selected occupation.

7. The system according to claim 1, wherein
the individual is associated with an entity, and
the at least one predetermined source, from which the current location information is obtained, includes a database of the entity, the database including position information associated with the entity throughout the plurality of locations, the current location information including the position information.

8. The system according to claim 7, wherein
the operations further include:
obtaining first skill information of the individual, the first skill information including an evaluation of at least one skill of the individual in association with the entity;
obtaining second skill information of a plurality of individuals, the second skill information including an evaluation of the at least one skill for each of the plurality of individuals, the plurality of individuals also being associated with the entity; and
correlating the first skill information of the individual with the second skill information of the plurality of individuals, and
the position information, included in the current location information, is obtained based on the correlating of the first skill information with the second skill information.

9. The system according to claim 8, wherein
the correlating of the first skill information with the second skill information includes determinations of whether the individual is likely to succeed at positions within the position information, and
the position information, which is included in the current location information, is filtered based on the determinations.

10. The system according to claim 8, wherein
the correlating of the first skill information with the second skill information includes determinations of whether the individual is likely to succeed at positions within the position information, and
the position information, which is included in the current location information, is weighted based on the determinations.

11. The system according to claim 7, wherein
the operations further include:
obtaining first profile information of the individual;
obtaining second profile information of a plurality of individuals, the plurality of individuals also being associated with the entity; and
correlating the first profile information of the individual with the second profile information of the plurality of individuals, and
the position information, included in the current location information, is obtained based on the correlating of the first profile information with the second profile information.

12. The system according to claim 7, wherein the operations further include:
comparing the individual occupation information with the position information to determine shortcomings of the individual occupation information for a position within the position information;
determining, based on the individual occupation information, a roadmap for overcoming the shortcomings for the position; and
providing the roadmap to the individual.

13. The system according to claim 12, wherein the roadmap for overcoming the shortcomings for the position is determined by accessing an employee profile of the individual, the employee profile being stored in the database of the entity.

14. The system according to claim 7, wherein
the processor automatically accesses at least one of a social media platform, a financial record, a phone record, or a credit history to obtain the individual preference information; and
the processor automatically accesses an employee profile of the individual to obtain the individual occupation information, the employee profile being stored in the database of the entity.

15. The system according to claim 1, wherein the obtaining of the individual preference information includes:
accessing, by the processor, a social media platform of the individual; and
identifying, as a lifestyle preference, locations of persons associated with the individual on the social media platform.

16. The system according to claim 1, wherein the obtaining of the individual occupation information includes:
accessing, by the processor, a social media platform of the individual; and
identifying locations of persons associated with the individual on the social media platform to determine locations of preference, the persons corresponding to the individual as networking opportunities.

17. The system according to claim 1, wherein the obtaining of the individual preference information includes:
accessing, by the processor, a phone record of a phone of the individual; and
identifying, as a lifestyle preference, at least one of destinations of outgoing communications, originations of incoming communications, or locations corresponding to a positioning trace of the phone.

18. The system according to claim 1, wherein the obtaining of the individual preference information includes:
accessing, by the processor, at least one of a financial record or a credit history of the individual; and
identifying at least one lifestyle preference of the individual based on the one of the financial record or the credit history.

19. A method for providing an individual with at least one option for relocation based on obtained information, the method comprising:
obtaining individual occupation information, the individual occupation information corresponding to at least one of a primary occupation of the individual, an employment history of the individual, or an education of the individual;
obtaining individual preference information, the individual preference information corresponding to at least one lifestyle preference of the individual;
obtaining current location information from at least one predetermined source, the current location information corresponding to a plurality of locations;
correlating the individual occupation information and the individual preference information with the current location information;
determining, with a processor and from among the plurality of locations and based on the correlating, at least one location as the at least one option for relocation; and
providing the at least one location as the at least one option for relocation to the individual.

20. A non-transitory computer-readable medium including a set of instructions for providing an individual with at least one option for relocation based on obtained information that, when executed by a computer, causes the computer to perform operations comprising:
obtaining individual occupation information, the individual occupation information corresponding to at least one of a primary occupation of the individual, an employment history of the individual, or an education of the individual;
obtaining individual preference information, the individual preference information corresponding to at least one lifestyle preference of the individual;
obtaining current location information from at least one predetermined source, the current location information corresponding to a plurality of locations;
correlating the individual occupation information and the individual preference information with the current location information;
determining, from among the plurality of locations and based on the correlating, at least one location as the at least one option for relocation; and
providing the at least one location as the at least one option for relocation to the individual.
